(19) United States
(12) Patent Application Publication
(10) Pub. No.: US 2012/0117166 A1
(43) Pub. Date: May 10, 2012

(54) Method and System of Communication Between Instant Messaging Clients and Mobile Cellular Devices

(76) Inventor: Vikrant Sharma, Windermerg, FL (US)

(21) Appl. No.: 13/024,912

(22) Filed: Feb. 10, 2011

Related U.S. Application Data
(60) Provisional application No. 61/303,067, filed on Feb. 10, 2010.

(51) Int. Cl. G06F 15/16

(52) U.S. Cl. 709/206

(57) ABSTRACT

A system of communication between instant messaging clients and mobile cellular devices is disclosed. The system includes an application on a mobile cellular device that encodes an SMS/MMS message with information that is used to convert the SMS/MMS message to an IM message protocol. The converted SMS/MMS message is sent to a SMS/MMS gateway and forwarded to an IM gateway based on the encoded information. The IM gateway sends the user the converted SMS/MMS message as an instant message. An application on the personal computer of an IM user encodes an instant message with information that is used to convert the instant message to an SMS/MMS message protocol. The converted instant message is sent to the IM gateway and forwarded to the SMS/MMS gateway based on the encoded information. The SMS/MMS gateway transmits the converted instant message and the SMS/MMS user receives the instant message on his/her mobile cellular device.

### I. CROSS-REFERENCE TO RELATED APPLICATIONS

This application claims the benefit of U.S. Provisional Application No. 61/303,067 filed Feb. 10, 2010. The disclosure of the provisional application is incorporated herein by reference.

### II. FIELD

The present disclosure is generally related to a method and system of communication between instant messaging clients and mobile cellular devices.

### III. DESCRIPTION OF RELATED ART

There is a need to allow short message service (SMS) and multimedia message system (MMS) users to communicate directly to instant messaging (IM) users. SMS is a method of communication between cell phones where a user can send and receive text messages. The maximum size of each text message is 160 characters. The SMS message is sent over a control channel rather than voice channel frequencies. MMS is method to send messages between cell phones that includes multimedia content such as pictures and videos and expands on the SMS capabilities. In contrast to SMS/MMS, IM is typically used between personal computers and an Internet connection using an IM provider's proprietary software (i.e., Instant Messaging Client). A user must log in to an IM provider server using the IMC that requests the IP address and number of the port assigned to the user's computer. If an intended recipient (i.e., second user) is also logged on to the same IM provider server, then instant messages can be sent and received directly between the first and second users over the Internet. The IM provider's server is not involved and all communication is directly between the two users using the IP address and port number for each user. However, there is no software available to allow a SMS/MMS message to be received by an IM user or for an IM message to be received by an SMS/MMS user.

It is, therefore, to the effective resolution of the aforementioned problems and shortcomings of the prior art that the present invention is directed.

### III. SUMMARY

In a particular embodiment, a method of communication between instant messaging clients and mobile cellular device clients is disclosed. The method includes sending a short message service message or multimedia message system (SMS/MMS) message to a SMS/MMS gateway server from a remote device, receiving the SMS/MMS message at the SMS/MMS gateway server, converting the SMS/MMS message to instant messaging (IM) protocol when the SMS/MMS message is intended for an IM client, forwarding a converted SMS/MMS message to an IM gateway server, sending the converted SMS/MMS message to the IM client, and receiving the converted SMS/MMS message by the IM client. In addition, the method may include converting the SMS/MMS message to the IM protocol using an interface application residing on the SMS/MMS gateway server, and encoding the SMS/MMS message with information for converting the SMS/MMS message to the IM protocol. The IM gateway server may be connected to an Internet.

In another particular embodiment, the method includes sending an instant messaging (IM) message to an IM gateway server from a remote device, receiving an IM message at the IM gateway server, converting the IM message to a short message service/multimedia message system (SMS/MMS) protocol when the IM message is intended for an SMS or MMS client, forwarding a converted IM message to a SMS/MMS gateway server, sending the converted IM message to the SMS or MMS client, and receiving the converted IM message by the SMS or MMS client. In addition, the method includes converting the IM message to the SMS/MMS protocol using an interface application residing on the IM gateway server. The IM message may be encoded with information for converting the IM message to the SMS/MMS protocol.

In another particular embodiment, the method includes sending a short message service or multimedia message system (SMS/MMS) message from a remote device, converting the SMS/MMS message to an instant messaging (IM) protocol when the SMS/MMS message is intended for an IM client, forwarding a converted SMS/MMS message to an IM gateway server, sending the converted SMS/MMS message to the IM client, and receiving the converted SMS/MMS message by the IM client. Further, the method includes converting the SMS/MMS message to the IM protocol using an interface application residing on the remote device and encoding the SMS/MMS message with information for converting the SMS/MMS message to the IM protocol.

In another particular embodiment, a method of communication between instant messaging clients and mobile cellular device clients is disclosed, The method includes sending an instant messaging (IM) message to an IM gateway server from a remote device, converting the IM message to short message service or multimedia message system (SMS/MMS) protocol when the IM message is intended for a SMS or MMS client, forwarding a converted IM message to a SMS/MMS gateway server, sending the converted IM message to the SMS or MMS client, and receiving the converted IM message by the SMS or MMS client. An interface application resides on the IM gateway server for converting the IM message to the SMS/MMS protocol. The IM message is encoded with information for converting the IM message to the SMS/MMS protocol.

In another particular embodiment, a system of communication between instant messaging clients and mobile cellular device clients is disclosed. The system includes a short message service or multimedia message system (SMS/MMS) message to send to an instant messaging (IM) user using a mobile cellular device, an application residing on the mobile cellular device to encode the SMS/MMS message with information that is used to convert the SMS/MMS message to an IM message protocol, and a SMS/MMS gateway server to receive a converted SMS/MMS message and forward to an IM gateway server based on the encoded information, where the IM gateway server forwards the converted SMS/MMS message as an IM message to a personal computer. The system also includes an IM application residing on the personal computer, where the IM application encodes the IM message with the information used to convert the IM message to SMS/MMS protocol. In addition, the system includes a converted IM message, where the converted IM message is sent to the IM gateway server and forwarded to the SMS/MMS gateway based on the encoded information, and where the SMS/MMS gateway server transmits the converted IM message to the mobile cellular device.

In another particular embodiment, a system of communication between instant messaging clients and mobile cellular device clients is disclosed. The system includes a short message service or multimedia message system (SMS/MMS) message to send to an instant messaging (IM) user using a mobile cellular device, an application residing on a SMS/MMS gateway server to encode the SMS/MMS message with information that is used to convert the SMS/MMS message to an IM message protocol, and an IM gateway server to receive a converted SMS/MMS message and forward the converted SMS/MMS message as an IM message to a personal computer. The system also includes an IM application residing on the IM gateway server, where the IM application encodes the IM message with the information used to convert the IM message to SMS/MMS protocol. A converted IM message is sent to the SMS/MMS gateway based on the encoded information, where the SMS/MMS gateway server transmits the converted IM message to the mobile cellular device.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a diagram of a particular illustrative embodiment of a system of communication between instant messaging users and mobile cellular device users where an interface application resides on the mobile cellular device and IM computer;

FIG. 2 is a diagram of a particular illustrative embodiment of a system of communication between instant messaging users and mobile cellular device users where an interface application resides on the respective gateway servers;

FIG. 3 is a flow diagram of a particular illustrative embodiment of a method of sending an SMS/MMS message to an instant messaging user where the interface application resides on the respective gateway servers;

FIG. 4 is a flow diagram of a particular illustrative embodiment of a method of sending an IM message to an SMS/MMS user where the interface application resides on the respective gateway servers;

FIG. 5 is a flow diagram of a particular illustrative embodiment of a method of sending an SMS/MMS message to an instant messaging user where the interface application resides on the mobile cellular device and IM client; and

FIG. 6 is a flow diagram of a particular illustrative embodiment of a method of sending an IM message to an SMS/MMS user where the interface application resides on the respective gateway servers.

### V. DETAILED DESCRIPTION

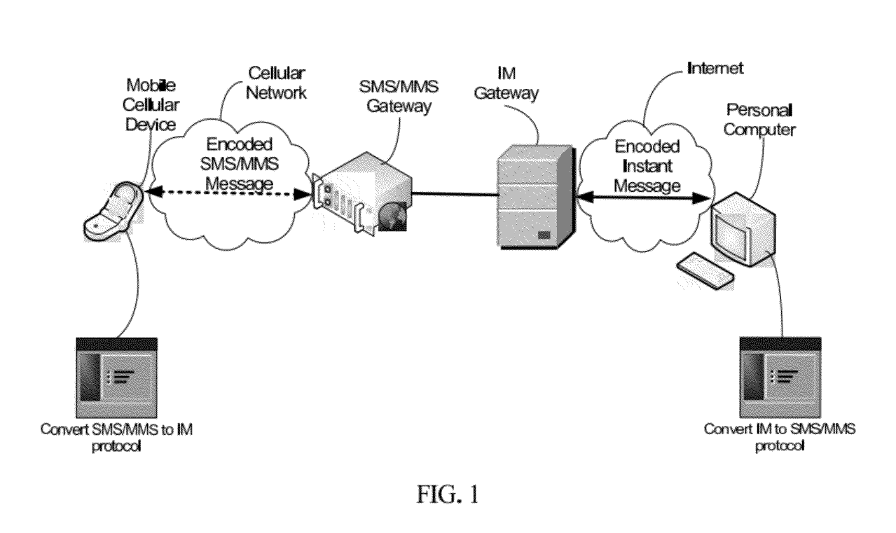

Referring now to FIG. 1, a user of a mobile cellular device selects an SMS/MMS message to be sent to an IM user. An application on the mobile cellular device encodes the SMS/MMS message with information that is used to convert the SMS/MMS message to an IM message protocol. The information may include, but not limited to, SMS, TCP/IP, instant messaging protocols, or other protocol or software. The converted SMS/MMS message is sent to the SMS/MMS gateway and forwarded to the IM gateway based on the encoded information. The IM gateway is connected to the Internet and sends the user the converted SMS/MMS message as instant message. Similarly, the IM user selects an instant message to be sent to a mobile cellular device user. An application on the personal computer encodes the instant message with information that is used to convert the instant message to an SMS/MMS message protocol. The converted instant message is sent to the IM gateway and forwarded to the SMS/MMS gateway based on the encoded information. The SMS/MMS gateway transmits the converted instant message and the SMS/MMS user receives the instant message on his/her mobile cellular device.

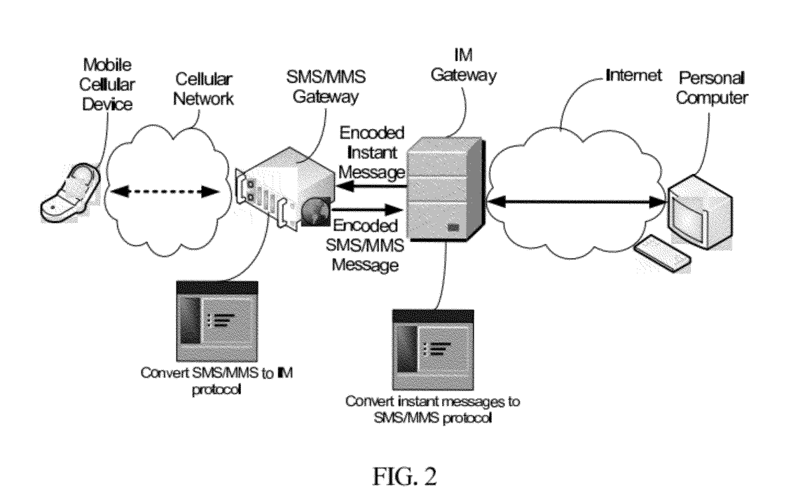

The application may also, or alternatively, reside on the SMS/MMS gateway and the IM gateway as shown in FIG. 2. Accordingly, the SMS/MMS message is sent to the SMS/MMS gateway where the application in encoded with information to convert the SMS/MMS message to an instant message. The encoded SMS/MMS message is forwarded to the IM gateway, which transmits the converted SMS/MMS message as an instant message to the IM user. In addition, an IM user may select an SMS/MMS user to send a message. The instant message is received by the IM gateway where the instant message is encoded with information to convert the instant message to an SMS/MMS message. The encoded IM message is forwarded to the SMS/MMS gateway to transmit the converted IM message as an SMS/MMS message to the mobile cellular device.

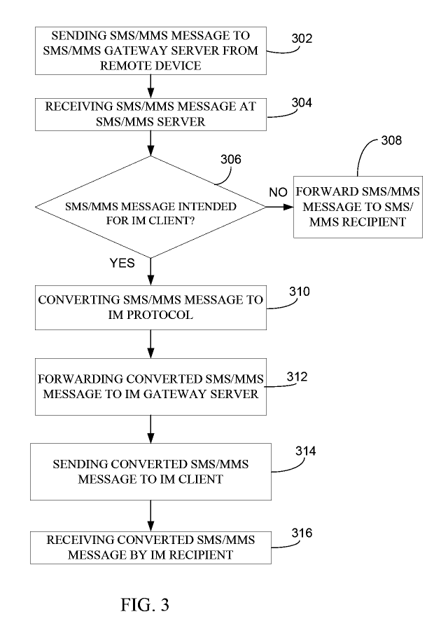

Referring now to FIG. 3, a method of method of communication between instant messaging clients and mobile cellular device clients is disclosed. At 302, a SMS/MMS message is sent to a gateway server from a remote device. The SMS/MMS message, at 304, is received at the SMS/MMS server. Moving to 306, whether an SMS/MMS message is intended for an IM client is determined. If the SMS/MMS message is not for an IM client, then the message is forwarded, at 308, without further processing by the application. If the SMS/MMS message is bound for an IM client, then, at 310, the SMS/MMS message is converted according to IM protocol. At 312, the converted SMS/MMS message is forwarded to an IM gateway server. The converted SMS/MMS message is then forwarded to the IM client, at 314, and received by the IM recipient, at 316.

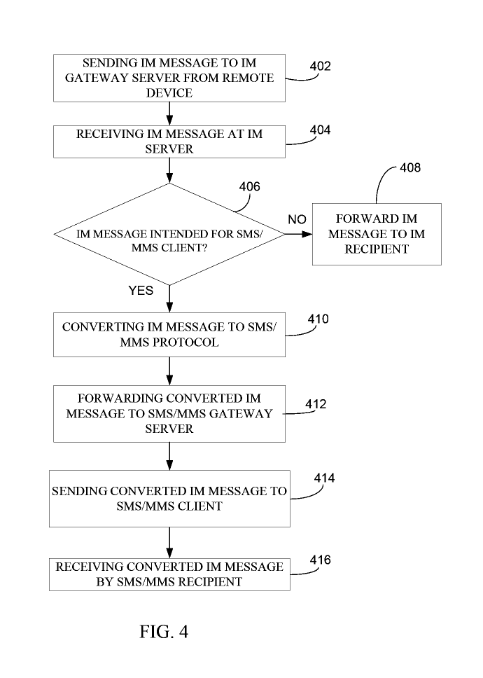

The IM user may send a message to a SMS/MMS user by the method shown in FIG. 4. For example, an IM message is sent to an IM gateway server, at 402. At 404, the message is received at the IM gateway server. If the IM message is intended for another IM user, then at 408, the IM message is forwarded to the IM recipient. Otherwise, the IM message is converted to SMS/MMS protocol, at 410. Moving to 412, the converted IM message is forwarded to the SMS/MMS gateway where the converted IM message is sent to the SMS/MMS client at 414. The converted IM message is received, at 416, by the SMS/MMS client.

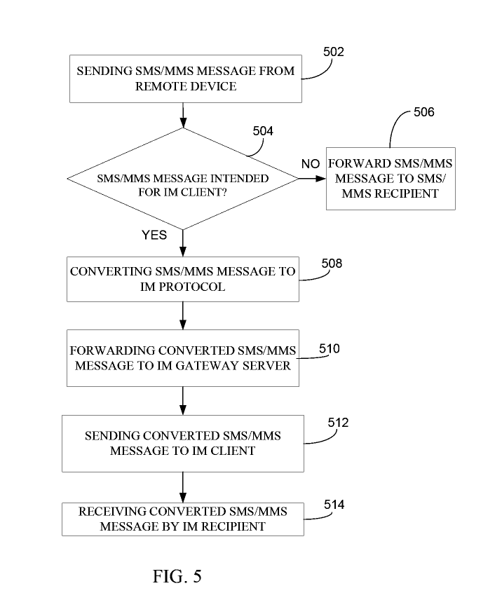

In another embodiment of a method of communication between instant messaging clients and mobile cellular device clients is shown in FIG. 5. In this embodiment, an SMS/MMS message is selected to be sent from a remote device, at 502. Before the SMS/MMS message is sent, it is determined, at 504, whether the SMS/MMS message is intended for an IM client. If the SMS/MMS message is intended for another SMS/MMS user, then the message is forwarded, at 506, without further processing. If the SMS/MMS message is intended for an IM client, then the SMS/MMS message is converted, at 508, to an IM protocol. At 510, the converted SMS/MMS message is forwarded to an IM gateway server. The converted SMS/MMS message may then be sent, at 512, to an IM client. The IM recipient then receives the converted SMS/MMS message using the IM client, at 514.

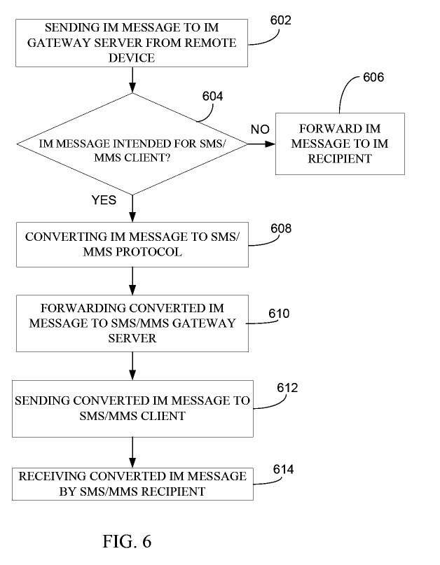

Referring now to FIG. 6, an IM message is sent to an IM gateway server from a remote device, at 602. Similar to that described above, it is determined whether the IM message is intended for an SMS/MMS client, at 604. If the intended recipient is another IM user, then, at 606, the IM message is forwarded to the IM recipient without encoding. Otherwise, at 608, the IM message is converted to SMS/MMS protocol. The converted IM message is forwarded to the SMS/MMS gateway server, at 610, and the SMS/MMS gateway server then sends the converted IM message to the SMS/MMS client, at 612. Continuing to 614, the converted IM message is received by the SMS/MMS recipient.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope possible consistent with the principles and novel features as defined herein.

What is claimed is:

1. A method of communication between instant messaging clients and mobile cellular device clients, the method comprising:
sending a short message service message or multimedia message system (SMS/MMS) message to a SMS/MMS gateway server from a remote device;
receiving the SMS/MMS message at the SMS/MMS gateway server;
converting the SMS/MMS message to instant messaging (IM) protocol when the SMS/MMS message is intended for an IM client;
forwarding a converted SMS/MMS message to an IM gateway server;
sending the converted SMS/MMS message to the IM client; and
receiving the converted SMS/MMS message by the IM client.

2. The method of claim 1, further comprising converting the SMS/MMS message to the IM protocol using an interface application residing on the SMS/MMS gateway server.

3. The method of claim 2, further comprising encoding the SMS/MMS message with information for converting the SMS/MMS message to the IM protocol.

4. The method of claim 3, further comprising connecting the IM gateway server to an Internet.

5. A method of communication between instant messaging clients and mobile cellular device clients, the method comprising:
sending an instant messaging (IM) message to an IM gateway server from a remote device;
receiving an IM message at the IM gateway server;
converting the IM message to a short message service/multimedia message system (SMS/MMS) protocol when the IM message is intended for an SMS or MMS client;
forwarding a converted IM message to a SMS/MMS gateway server;
sending the converted IM message to the SMS or MMS client; and receiving the converted IM message by the SMS or MMS client.

6. The method of claim 5, further comprising converting the IM message to the SMS/MMS protocol using an interface application residing on the IM gateway server.

7. The method of claim 6, further comprising encoding the IM message with information for converting the IM message to the SMS/MMS protocol.

8. A method of communication between instant messaging clients and mobile cellular device clients, the method comprising:
sending a short message service or multimedia message system (SMS/MMS) message from a remote device;
converting the SMS/MMS message to an instant messaging (IM) protocol when the SMS/MMS message is intended for an IM client;
forwarding a converted SMS/MMS message to an IM gateway server;
sending the converted SMS/MMS message to the IM client; and
receiving the converted SMS/MMS message by the IM client.

9. The method of claim 8, further comprising converting the SMS/MMS message to the IM protocol using an interface application residing on the remote device.

10. The method of claim 9, further comprising encoding the SMS/MMS message with information for converting the SMS/MMS message to the IM protocol.

11. A method of communication between instant messaging clients and mobile cellular device clients, the method comprising:
sending an instant messaging (IM) message to an IM gateway server from a remote device;
converting the IM message to short message service or multimedia message system (SMS/MMS) protocol when the IM message is intended for a SMS or MMS client;
forwarding a converted IM message to a SMS/MMS gateway server;
sending the converted IM message to the SMS or MMS client; and
receiving the converted IM message by the SMS or MMS client.

12. The method of claim 11, comprising converting the IM message to the SMS/MMS protocol using an interface application residing on the IM gateway server.

13. The method of claim 12, further comprising encoding the IM message with information for converting the IM message to the SMS/MMS protocol.

14. A system of communication between instant messaging clients and mobile cellular device clients, the system comprising:
a short message service or multimedia message system (SMS/MMS) message to send to an instant messaging (IM) user using a mobile cellular device;
an application residing on the mobile cellular device to encode the SMS/MMS message with information that is used to convert the SMS/MMS message to an IM message protocol; and
a SMS/MMS gateway server to receive a converted SMS/MMS message and forward to an IM gateway server based on the encoded information;
wherein the IM gateway server forwards the converted SMS/MMS message as an IM message to a personal computer.

15. The system of claim 14, further comprising:
an IM application residing on the personal computer, wherein the IM application encodes the IM message with the information used to convert the IM message to SMS/MMS protocol; and
a converted IM message, wherein the converted IM message is sent to the IM gateway server and forwarded to the SMS/MMS gateway based on the encoded information;
wherein the SMS/MMS gateway server transmits the converted IM message to the mobile cellular device.

16. A system of communication between instant messaging clients and mobile cellular device clients, the system comprising:
a short message service or multimedia message system (SMS/MMS) message to send to an instant messaging (IM) user using a mobile cellular device;
an application residing on a SMS/MMS gateway server to encode the SMS/MMS message with information that is used to convert the SMS/MMS message to an IM message protocol; and
an IM gateway server to receive a converted SMS/MMS message and forward the converted SMS/MMS message as an IM message to a personal computer.

17. The system of claim 16, further comprising:
an IM application residing on the IM gateway server, wherein the IM application encodes the IM message with the information used to convert the IM message to SMS/MMS protocol; and
a converted IM message, wherein the converted IM message is sent to the SMS/MMS gateway based on the encoded information;
wherein the SMS/MMS gateway server transmits the converted IM message to the mobile cellular device.
